(19) United States
(12) Patent Application Publication
(10) Pub. No.: US 2019/0351759 A1
(43) Pub. Date: Nov. 21, 2019

(54) FUEL TANK FILL ASSEMBLY

(71) Applicant: Stant USA Corp., Connersville, IN (US)

(72) Inventor: Ricky A. WILLIS, Richmond Twp, MI (US)

(21) Appl. No.: 16/363,390

(22) Filed: Mar. 25, 2019

Related U.S. Application Data
(60) Provisional application No. 62/674,191, filed on May 21, 2018.

(51) Int. Cl. B60K 15/04

(52) U.S. Cl. CPC B60K 15/04; B60K 2015/03019

(57) ABSTRACT

A fuel tank fill assembly includes a fuel fill tube adapted to be coupled to a fuel tank and configured to receive fuel discharged by a pump nozzle. The assembly also includes a tube mounting bracket for mounting the fuel fill tube in a stationary position in a vehicle to conduct fuel to the fuel tank.

### PRIORITY CLAIM

This application claims priority under 35 U.S.C. § 119(e) to U.S. Provisional Application No. 62/674,191, filed May 21, 2018, which is expressly incorporated by reference herein.

### BACKGROUND

The present disclosure relates to a fuel tank fill assembly. More particularly, the present disclosure relates to a fuel tank fill assembly for a vehicle fuel tank.

### SUMMARY

According to the present disclosure, a fuel tank fill assembly comprises an inlet cup and a fuel filler pipe extending from the inlet cup to a fuel tank. The fuel filler pipe is adapted to conduct liquid fuel from the inlet cup to the fuel tank during refueling.

In illustrative embodiments, a filler-pipe anchor bracket is mounted on the fuel filler pipe made of carbon steel using welds to provide an uncoated fuel-delivery conduit that can be used to conduct liquid fuel to a vehicle fuel tank. The pipe mount of the filler-pipe anchor bracket is coupled to the fuel filler pipe in accordance with the present disclosure to maximize application of a two-layer protective coating to all exposed portions of the filler pipe anchor bracket, the welds, and the fuel filler pipe that are included in the uncoated fuel-delivery conduit and especially in a dual-coat flow gap formed between the pipe mount and the fuel filler pipe in accordance with the present disclosure so that corrosion of the filler pipe anchor bracket and fuel filler pipe is minimized.

In an illustrative process in accordance with the present disclosure, a pipe mount of the filler-pipe anchor bracket is mounted on the fuel filler pipe to form a dual-coat flow gap therebetween. Then a corrosion-resistant first coating material is applied to an exposed inner surface of the pipe mount and an opposed exterior surface of the fuel filler pipe to establish a first coating layer in the dual-coat flow gap. Subsequently, a corrosion-resistant second coating material is applied to exposed surfaces of the first coating layer to establish a second coating layer in the dual-coat flow gap. That gap is sized to allow the first and second coating materials to flow into the gap in sequence to establish a multi-layer protective coating on the pipe mount and the fuel filler pipe in the dual-coat flow gap. The multi-layer protective coating is applied to the inlet cup in addition to the fuel filler pipe and the filler-pipe anchor bracket to provide a corrosion-resistant fuel tank fill assembly.

In illustrative embodiments, the pipe mount is welded to the fuel filler pipe to form the dual-coat flow gap between the pipe mount and a convex exterior surface of the fuel filler pipe. A mount-support flange also included in the filler-pipe anchor bracket is coupled to the pipe mount and arranged to extend away from the fuel filler pipe to accommodate coupling of the filler-pipe anchor bracket to another component of a vehicle, e.g., a vehicle frame.

In illustrative embodiments, the pipe mount of the filler-pipe anchor bracket is formed to include first and second welding bases that are welded to the fuel filler pipe using welds. The pipe mount also includes a web that extends between the first and second welding bases to provide a coating bridge. The coating bridge is spaced apart from the convex exterior surface of the pipe segment of the filler pipe to form therebetween a dual-coat flow gap in accordance with the present disclosure when the pipe mount is welded to the fuel filler pipe.

In illustrative embodiments, the pipe mount includes a curved band comprising, in sequence, an end tab, a coating bridge, and a flange connector. The first welding base is coupled to an underside of the coating bridge to lie near the end tab. The second welding base is coupled to the underside of the coating bridge to lie near the flange connector. The flange connector is coupled to the mount-support flange.

In illustrative embodiments, the dual-coat flow gap is sized to provide means for allowing a first coating material such as an undercoat zinc-rich primer and then a second coating material such as a top-coat anti-corrosion paint to move into the dual-coat flow gap and coat the interior surface of the pipe mount and the opposed exterior surface of the fuel filler pipe so that portions of the uncoated fuel-delivery conduit in the dual-coat flow gap are now coated and thus protected from corrosive influences during use. A protective coating comprising the first and second coating materials is also applied to exterior portions of the fuel filler pipe, filler-pipe anchor bracket, pipe/bracket welds, and the inlet cup to improve corrosion-resistance of the fuel tank fill assembly. The result is that a corrosion-resistant fuel tank fill assembly is provided in accordance with the present disclosure.

Additional features of the disclosure will become apparent to those skilled in the art upon consideration of illustrative embodiments exemplifying the best mode of carrying out the disclosure as presently perceived.

### BRIEF DESCRIPTION OF THE DRAWING

The detailed description particularly refers to the accompanying figures in which:

FIG. 1 is a side elevation view of a fuel system including a fuel tank and a fuel tank fill assembly for conducting fuel into the fuel tank during refueling and showing that the fuel tank fill assembly includes an inlet cup, a fuel filler pipe that extends from the inlet cup to the fuel tank, and a coating maximizer filler-pipe anchor bracket mounted to the fuel filler pipe as shown in FIG. 2 in accordance with the present disclosure to provide a dual-coat flow gap that is sized as suggested in FIGS. 3 and 4 to receive therein a corrosion-resistant first coating material as suggested in FIG. 5 and then a corrosion-resistant second coating material as suggested in FIG. 6;

FIG. 2 is an enlarged view of a portion of the fuel tank fill assembly of FIG. 1 before a two-layer protective coating is applied to an uncoated fuel-delivery conduit comprising the fuel filler pipe and the coating maximizer filler-pipe anchor bracket welded to the fuel filler pipe (the protective coating is applied using an illustrative two-stage coating process suggested in FIGS. 4-6) and showing that the coating maximizer filler-pipe anchor bracket includes a pipe mount arranged to wrap partly around the fuel filler pipe and a mount-support flange coupled to the pipe mount and arranged to extend away from the pipe mount and further showing that the pipe mount is positioned on the fuel filler pipe such that a dual-coat flow gap in accordance with the present disclosure is formed between the pipe mount and a convex exterior surface of the fuel filler pipe as shown in FIG. 3;

FIG. 3 is a sectional view taken along line 3-3 of FIG. 2 showing the pipe mount includes a curved band comprising an end tab, a coating bridge, and a flange connector, a first welding base coupled to an underside of the coating bridge, and a first of two second welding bases coupled to the underside of the coating bridge and showing that the first welding base is welded to the fuel filler pipe and the first of two second welding bases is welded to the fuel filler pipe, and further showing that the dual-coat flow gap is provided between the first and second welding bases and between the coating bridge and the fuel filler pipe and is sized to allow an undercoat zinc-rich primer and a top-coat anti-corrosion paint (1) to cover exterior portions of the fuel filler pipe, filler-pipe anchor bracket, and pipe/bracket welds and (2) to move in sequence into the dual-coat flow gap and coat a convex exterior surface of the fuel filler pipe and an opposed inner surface of the pipe mount after the pipe mount of the filler-pipe anchor bracket has been welded to the fuel filler pipe so that a multi-layer protective coating is established on the uncoated fuel-delivery conduit as suggested in FIGS. 4-6;

FIGS. 4-6 show a two-stage sequence for applying corrosion-resistant first and second coating materials to the pipe mount, the fuel filler pipe, and welds applied to the pipe mount and fuel filler pipe to establish a first coating layer comprising a zinc-rich primer and then a second coating layer comprising an anti-corrosion paint in the dual-coat flow gap formed between the pipe mount and the fuel filler pipe and on other exterior surfaces of the pipe mount, fuel filler pipe, and pipe welds;

FIG. 4 shows welding of the pipe mount to the fuel filler pipe to establish a dual-coat flow gap between an inner surface of the pipe mount and an opposed convex exterior surface of the fuel filler pipe;

FIG. 5 shows introduction of a corrosion-resistant first coating material into the dual-coat flow gap formed between the pipe mount and the fuel filler pipe in accordance with the present disclosure to establish a first coating layer on exposed surfaces of the pipe mount and the fuel filler pipe and also shows application of the first coating material to other exposed surfaces of the pipe mount, fuel filler pipe, and welds; and

FIG. 6 shows subsequent introduction of a corrosion-resistant second coating material into the dual-coat flow gap in accordance with the present disclosure to establish a second coating layer on exposed surfaces of the first coating layer and also shows application of the second coating material to other exposed surfaces of the first coating layer.

### DETAILED DESCRIPTION

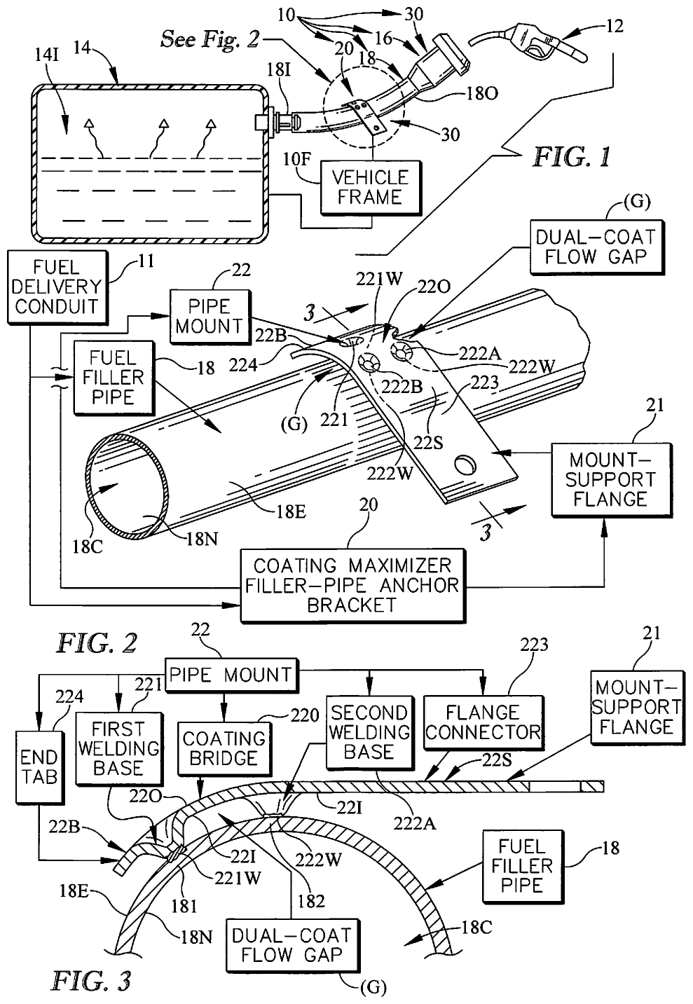

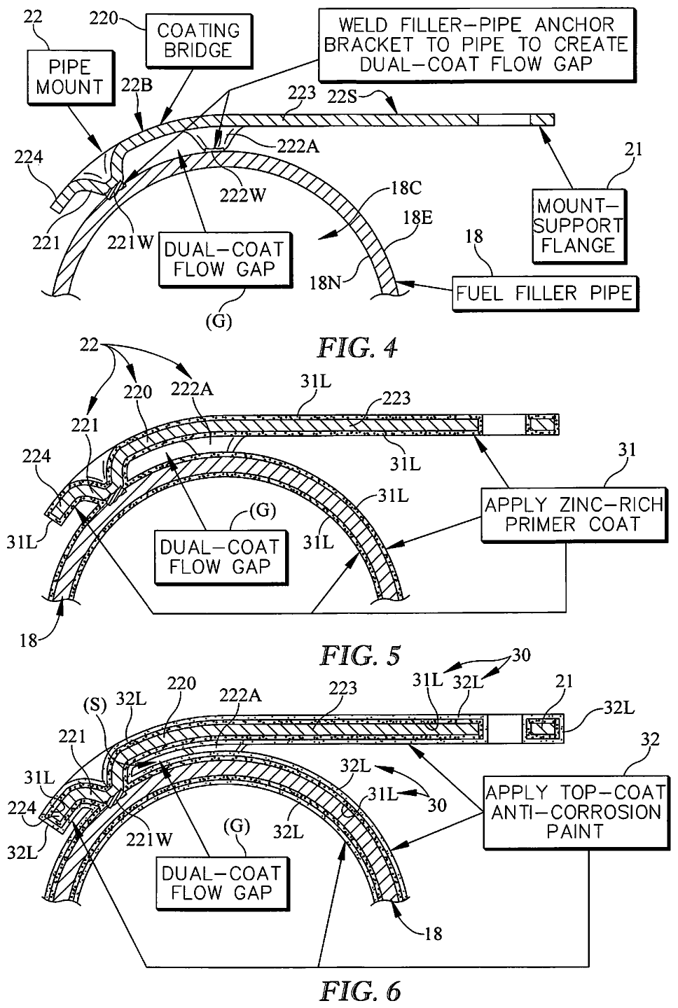

A fuel tank fill assembly 10 is configured to conduct fuel from a fuel-dispensing pump nozzle 12 to a fuel tank 14 as suggested in FIG. 1. Fuel fill tank assembly 10 includes an inlet cup 16 sized to receive nozzle 12, a fuel filler pipe 18 configured to conduct liquid fuel discharged by nozzle 12 into inlet cup 16 to an interior region 14I of fuel tank 14, and a filler-pipe anchor bracket 20. Fuel tank fill assembly 10 also includes a two-layer corrosion-resistant protection coating 30 applied in accordance with the present disclosure as suggested in FIGS. 4-6.

Filler-pipe anchor bracket 20 is mounted on fuel filler pipe 18 using welds 221W and 222W to produce an uncoated fuel-delivery conduit 11 as suggested in FIG. 2 and to establish a dual-coat flow gap (G) between fuel filler pipe 18 and filler-pipe anchor bracket 20 as suggested in FIGS. 3 and 4. A corrosion-resistant protective coating 30 is applied to the uncoated fuel-delivery conduit 11 as suggested in FIGS. 5 and 6 so that exposed portions of pipe 18 and bracket 20 bordering dual-coat flow gap (G) are coated in accordance with the present disclosure along with all other exposed portions of the uncoated fuel-delivery conduit 11. It is within the scope of the present disclosure to vary the configuration of coating maximizer filler-pipe anchor bracket 20 to produce various dual-coat flow gaps.

In a two-step coating sequence used to coat the uncoated fuel-delivery conduit 11 and illustrated in FIGS. 5 and 6, a corrosion-resistant first coating material 31 flows onto filler-pipe anchor bracket 20 and fuel filler pipe 18 and into dual-coat flow gap (G) to form a first coating layer 31L in dual-coat flow gap (G). Next, a corrosion-resistant second coating material 32 flows onto the first coating layer 31L on filler-pipe anchor bracket 20 and fuel filler pipe 18 and into dual-coat flow gap (G) to form a second coating layer 32L in dual-coat flow gap (G). These coating layers 31L, 32L cooperate to form a multi-layer corrosion-resistant protective coating 30 all over fuel-delivery conduit 11 and inside the dual-coat flow gap (G) associated with fuel-delivery conduit 11 in accordance with the present disclosure.

In illustrative embodiments of the present disclosure, fuel filler pipe 18 is made of carbon steel, first coating material 31 is an undercoat zinc-rich primer, and second coating material 32 is a top-coat anti-corrosion paint made, for example, of a durable thermoset material. It is within the scope of the present disclosure to apply second coating material 32 to a carbon steel pipe carrying an electroplated zinc-nickel primer using dip, drain, or spray applications. In accordance with the present disclosure, the multi-layer corrosion-resistant protective coating 30 is applied to an uncoated fuel-delivery conduit 11 to provide a fuel tank fill assembly 10 shown in FIGS. 1 and 6 that meets established fifteen year laboratory and vehicle corrosion testing standards.

Fuel filler pipe 18 of fuel-delivery conduit 11 includes a nozzle-receiving outer end 18O associated with and linked to inlet cup 16 and a fuel-discharging inner end 18I adapted to be coupled to fuel tank 14 to discharge fuel into interior region 14I of fuel tank 14 as shown in FIG. 1. Fuel filler pipe 18 also includes an interior surface 18N arranged to define a fuel-conducting conduit 18C extending between and interconnecting nozzle-receiving outer end 18O and fuel-discharging inner end 18I and an exterior surface 18E that is curved and arranged to face away from fuel-conducting conduit 18C as shown in FIGS. 2 and 3.

Coating maximizer filler-pipe anchor bracket 20 of the uncoated fuel-delivery conduit 11 includes a mount-support flange 21 and a pipe mount 22 as shown in FIGS. 1-3. Filler-pipe anchor bracket 20 is made of carbon steel in illustrative embodiments. Mount-support flange 21 is adapted to be coupled to a vehicle frame 10F to support fuel filler pipe 18 relative to vehicle frame 10F to cause fuel-discharging inner end 18I to communicate with interior region 14I of fuel tank 14. Pipe mount 22 is coupled to mount-support flange 21 and to exterior surface 18E of fuel filler pipe 18 to retain mount-support flange 21 in fixed relation to fuel filler pipe 18. Pipe mount 22 includes an inner surface 22I facing toward exterior surface 18E of fuel filler pipe 18 as shown in FIG. 3.

Multi-layer protective coating 30 covers exposed portions of exterior surface 18E of fuel pipe 18, inner and outer surfaces 22I, 22O of pipe mount 22, and inlet cup 16 as suggested in FIGS. 1 and 6. In illustrative embodiments, multi-layer protective coating 30 also covers an inner surface 18N of fuel filler pipe 18 as shown in FIG. 6. Protective coating 30 comprises a first coating layer 31L made of primer 31 and adhered to exterior surface 18E of fuel filler pipe 18 and inner and outer surfaces 22I, 22O of pipe mount 22 and a second coating layer 32L made of paint 32 and adhered to exposed surfaces of first coating layer 31L as suggested in FIG. 6.

Flow gap (G) is sized in accordance with the present disclosure to allow a zinc-rich primer 31 and a top-coat anti-corrosion paint 32 to flow into flow gap (G) when the primer 31 and paint 32 are applied in sequence as suggested in FIGS. 5 and 6 after the filler-pipe anchor bracket 20 has been welded to the fuel filler pipe 18 using welds 221W, 222W as suggested in FIG. 4. Inner surface 22I of pipe mount 22 of coating maximizer filler-pipe anchor bracket 20 and an opposed portion of convex exterior surface 18E of fuel filler pipe 18 are arranged to lie in confronting spaced-apart relation to one another as shown, for example, in FIGS. 2 and 3. Inner surface 22I and the opposed portion of convex exterior surface 18E cooperate to form therebetween dual-coat flow gap (G) means for first allowing first coating layer 31L to adhere to exposed portions of inner surface 22I of pipe mount 22 and the undercoat primer 31 on the opposed portion of convex exterior surface 18E of fuel filler pipe 18 during deposition of first coating layer 31L on pipe mount 22 and fuel filler pipe 18 and thereafter allowing second coating layer 32L of top-coat paint 32 to adhere to exposed portions of first coating layer 31L located in a dual-coat flow gap (G) provided between pipe mount 22 and fuel filler pipe 18. An exposed surface of second coating layer 32L located in the dual-coat flow gap (G) cooperates to form an open space (S) located between pipe mount 22 and the opposed portion of convex exterior surface 18E of fuel filler pipe 18 as suggested in FIG. 6.

Pipe mount 22 of filler-pipe anchor bracket 20 includes an end tab 224, a coating bridge 220 arranged to lie in spaced-apart relation to an opposed portion of convex exterior surface 18E of fuel filler pipe 18, and a flange connector 223, a first welding base 221 coupled to a first end of coating bridge 220 and welded to exterior portion 18E of fuel filler pipe 18, and a pair of second welding bases 222A, 222B coupled to an opposite second end of coating bridge 220 and welded to exterior surface 18E of fuel filler pipe 18 as shown, for example, in FIGS. 3 and 4 to define the dual-coat flow gap (G) between pipe mount 22 and fuel filler pipe 18. First welding base 221 is located near end tab 224. The two second welding bases 222A, 222B are located near flange connector 223 and are arranged to lie in laterally spaced-apart relation to one another as suggested in FIG. 2.

Pipe mount 22 includes a band including a curved band section 22B comprising end tab 224 and coating bridge 220 and a straight band section 22S comprising flange connector 223, as suggested in FIGS. 2 and 3. The curved band section 22B is wrapped around about one-eighth of the circumference of the curved exterior surface 18E of fuel filler pipe 18 as shown in FIGS. 2 and 3. A first portion of material in the curved section 22B is deformed under a load using a tool to produce a downward extending dome-shaped first welding base 221 and suggested in FIGS. 2 and 3. Each of second and third portions of material in the curved section 22B is deformed under load using a tool to produce two separate and laterally spaced-apart and downwardly extending dome-shaped second welding bases 222A, 222B as suggested in FIGS. 2 and 3. The curved section 22B also includes the first welding base 221 and the two welding bases 222A, 222B. A free end of first welding base 221 is welded to convex exterior surface 18E of fuel filler pipe 18 using weldment 221W. A free end of each of second welding bases 222A, 222B is welded to convex exterior surface 18E of fuel filler pipe 18 using weldment 222W.

A first weldment 221W is mated with an exterior surface of first welding base 221 and exterior surface 18E of fuel filler pipe 18 as suggested in FIG. 4. A second weldment 222W is mated with an exterior surface of each of second welding bases 222A, 222B and exterior surface 18E of fuel filler pipe 18 as suggested in FIG. 4. First coating layer 31L is adhered to each of the first and second weldments 221W, 222W and has a uniform thickness inside and outside the dual-coat flow gap (G) in illustrative embodiments. Second coating layer 32L has a uniform thickness inside and outside of the dual-coat flow gap (G) in illustrative embodiments.

An illustrative process for providing a fuel tank fill assembly 10 comprises the steps of forming a dual-coat flow gap (G) between a convex exterior surface 18E of fuel filler pipe 18 and an opposed inner surface 22I of pipe mount 22 when pipe mount 22 is mounted on exterior surface 18E of fuel filler pipe 18 as suggested in FIGS. 3 and 4 during an assembly sequence and applying a multi-layer corrosion-resistant protective coating 30 to exposed portions of pipe mount 22, fuel filler pipe 18, and welds 221W, 222W after the forming step as suggested in FIGS. 5 and 6.

The forming step in accordance with the present disclosure comprises the steps of welding the first welding base 221 to a first portion 181 of exterior surface 18E of fuel filler pipe 18 and welding the two second welding bases 222A, 222B to a second portion 182 of exterior surface 18E of fuel filler pipe 18 to size the dual-coat flow gap (G) defined between the convex exterior surface 18E of fuel filler pipe 18, the opposed surfaces on the first welding base 221, coating bridge 220, and two second welding bases 222A, 222B of the pipe mount 22 to receive a multi-layer corrosion-resistant protective coating 31, 32 in the dual-coat flow gap (G). Flange connector 223 of pipe mount 22 is coupled to mount-support flange 21 as shown, for example, in FIG. 2.

The coating applying step in accordance with the present disclosure includes the steps of first introducing a corrosion-resistant first coating material 31 into the dual-coat flow gap (G) to establish a first coating layer 31L located in the dual-coat flow gap (G) and adhered to convex exterior surface 18E of fuel filler pipe 18 and the opposed inner surface 22I of pipe mount 22 and then introducing a corrosion-resistant second coating material 32 into the dual-coat flow gap (G) to establish a second coating layer 32L on exposed portions of the first coating layer 31L located in the dual-coat flow gap (G) so that a multi-layer corrosion-resistant protective coating 30 is present in the dual-coat flow gap (G) on portions of convex exterior surface 18E of fuel filler pipe 18 and the opposed inner surface 22I of the pipe mount 22 that cooperate to define a boundary of the dual-coat flow gap (G) as suggested in FIG. 6. An open space (S) surrounded by the second coating layer 32L is formed in the dual-coat flow gap (G) during the second introducing step. The first coating material 31 is an undercoat zinc-rich primer and the second coating material 32 is a top-coat anti-corrosion paint in illustrative embodiments.

Dual-coat flow gap (G) is sized to allow zinc-rich primer 31 and top-coat anti-corrosion paint 32 to move into dual-coat flow gap (G). Flow gap (G) is formed in accordance with the present disclosure to allow zinc-rich primer 31 and top-coat anti-corrosion paint 32 to coat a portion of exterior surface 18E of fuel filler pipe 18 upon application of the zinc-rich primer 31 and the top-coat anti-corrosion paint 32 when filler-pipe anchor bracket 20 is coupled to fuel filler pipe 18. It is contemplated that dual-coat flow gap (G) may be sized to a suitable height designed to facilitate the flow of primer and/or paint between fuel filler pipe 18 and pipe mount 22.

1. A process for providing a fuel tank fill assembly, the process comprising the steps of
forming a dual-coat flow gap between a convex exterior surface of a fuel filler pipe and an opposed inner surface of a pipe mount included in a filler-pipe anchor bracket when the pipe mount is mounted on the convex exterior surface of the fuel filler pipe to produce an uncoated fuel-delivery conduit, the forming step comprising the steps of welding a first welding base included in the pipe mount to a first portion of the convex exterior surface of the fuel filler pipe and welding two second welding bases included in the pipe mount and arranged to lie in spaced-apart relation to the first welding base to a second portion of the convex exterior surface of the fuel filler pipe to size the dual-coat flow gap defined between the convex exterior surface of the fuel filler pipe and opposed surfaces on the first welding base, the two second welding bases, and a coating bridge included in the pipe mount and coupled to the first and second welding bases to receive a multi-layer protective coating in the dual-coat flow gap, and
applying a multi-layer protective coating to exposed portions of the pipe mount and the fuel filler pipe included in the uncoated fuel-delivery conduit after the forming step, the applying step including the steps of first introducing a first coating material into the dual-coat flow gap to establish a first coating layer located in the dual-coat flow gap and adhered to the convex exterior surface of the fuel filler pipe and the opposed inner surface of the pipe mount and then second introducing a second coating-material into the dual-coat flow gap to establish a second coating layer on exposed portions of the first coating layer located in the dual-coat flow gap so that a multi-layer protective coating is present in the dual-coat flow gap on portions of the convex exterior surface of the fuel filler pipe and the opposed inner surface of the pipe mount that cooperate to define a boundary of the dual-coat flow gap.

2. The process of claim 1, wherein the filler-pipe anchor bracket further includes a mount-support flange that is adapted to be coupled to a vehicle frame to support the fuel filler pipe in a fixed position relative to the vehicle frame, the pipe mount further includes a flange connector coupled to the mount-support flange and an end tab arranged to lie in spaced-apart relation to the flange connector to locate the first welding base, the coating bridge, and the two second welding bases between the end tab and the flange connector.

3. The process of claim 1, wherein the pipe mount of the filler-pipe anchor bracket includes an end tab and a flange connector, the coating bridge is arranged to interconnect the end tab and the flange connector, the first welding base is coupled to a first end of the coating bridge to lie adjacent to the end tab, and the two second welding bases are coupled to an opposite second end of the coating bridge to lie adjacent to the flange connector.

4. The process of claim 3, wherein the coating bridge has a length extending between the end tab and the flange connector and a width that is less than the length and the two second welding bases are arranged to lie in laterally spaced-apart relation to one another across the width of the coating bridge.

5. The process of claim 4, wherein each of the first welding base, a first of the two second welding bases, and a second of the two second welding bases is a vertex of a reference triangle having three edges.

6. The process of claim 3, wherein the pipe mount includes a curved band comprising the end cap and the coating bridge.

7. The process of claim 6, wherein the forming step further comprises the steps of deforming a first portion of material in the curved band under a load using a tool to produce a downwardly extending dome-shaped element defining the first welding base and deforming second and third portions of material in the curved band under load using a tool to produce two separate and laterally spaced-apart and downwardly extending dome-shaped elements defining the two second welding bases.

8. A process for providing a fuel tank fill assembly, the process comprising the steps of
mounting a filler-pipe anchor bracket on a fuel filler pipe to produce an uncoated fuel-delivery conduit and to establish a dual-coat flow gap between the fuel filler pipe and the filler-pipe anchor bracket, the mounting step comprising the steps of engaging a pipe mount included in the filler-pipe anchor bracket to a curved exterior surface of the fuel filler pipe to form a dual-coat flow gap between the curved exterior surface of the fuel filler pipe and an opposed inner surface of the pipe mount, the engaging step comprising the steps of
wrapping a band included in the pipe mount and formed to include several welding bases partly around the curved exterior surface of the fuel filler pipe and welding free ends of each of the several welding bases to the curved exterior surface of the fuel filler pipe to hold the band in a stationary position surrounding a portion of the fuel filler pipe so as to form the dual-coat flow gap between the curved exterior surface of the fuel filler pipe and inner surfaces of the band that provide the opposed inner surface of the pipe mount and
applying a multi-layer protective coating to exposed portions of the pipe mount and the fuel filler pipe included in the uncoated fuel-delivery conduit after the mounting step, the applying step including the steps of first introducing a first coating material into the dual-coat flow gap to establish a first coating layer located in the dual-coat flow gap and adhered to the curved exterior surface of the fuel filler pipe and the opposed inner surface of the pipe mount and then second introducing a second coating material into the dual-coat flow gap to establish a second coating layer on exposed portions of the first coating layer located in the dual-coat flow gap so that multi-layer protective coating is present in the dual-coat flow gap on portions of the curved exterior surface of the fuel filler pipe and the opposed inner surface of the pipe mount that cooperate to define a boundary of the dual-coat flow gap.

9. The process of claim 8, wherein the filler-pipe anchor bracket further includes a mount-support flange that is adapted to be coupled to a vehicle frame to support the fuel filler pipe in a fixed position relative to the vehicle frame and the band includes a curved section that is wrapped around about one-eighth of a circumference of the curved exterior surface of the fuel filler pipe and a flange connector that is arranged to interconnect the curved section and the mount-support flange.

10. The process of claim 9, wherein the curved section of the band includes an end tab at a free end of the curved section and a coating bridge that is arranged to interconnect the end tab and the flange connector and formed to include the several welding bases.

11. The process of claim 10, wherein one of the several welding base in the curved section of the band is coupled to a first end of the coating bridge to lie adjacent to the end tab and the two of the several welding bases in the curved section of the band are coupled to an opposite second end of the coating bridge to lie adjacent to the flange connector.
